(19) United States
(12) Patent Application Publication
(10) Pub. No.: US 2016/0292665 A1
(43) Pub. Date: Oct. 6, 2016

(54) INTERACTIVE IN-FACILITY VIRTUAL ASSISTANT

(71) Applicant: Mikel Vincent Blanchard, Orange, CA (US)

(72) Inventor: Mikel Vincent Blanchard, Orange, CA (US)

(21) Appl. No.: 14/672,987

(22) Filed: Mar. 30, 2015

(51) Int. Cl. G06Q 20/32; G06Q 20/20; H04W 4/02

(52) U.S. Cl. CPC G06Q 20/3224; H04W 4/02; G06Q 20/208; G06Q 20/3274

(57) ABSTRACT

Various embodiments herein each include systems, methods, software, and devices that contribute in providing interactive in-facility virtual assistance to facility visitors, such as visitors to retail outlets. One method embodiment that may be implemented on a networked server includes initiating a transaction session between a mobile device and a terminal in response to an initiation input received via a network from the mobile device. The method of such embodiments may then transmit a facility location identifier received from the mobile device to the terminal. Other embodiments may be implemented on one or more of a mobile device, a terminal, a server, and other such computing devices.

### BACKGROUND INFORMATION

When visiting a facility, such as a retail store or library, visitors often seek out assistance. However, during peak period, facility employee numbers are insufficient to promptly meet assistance needs of all visitors. Such a lack of assistance capacity can result in negative visitor experiences, lost sales, and lost visitor loyalty. However, during non-peak periods, there may be more facility employees than needed, but at the same time, another associated facility may be experiencing a peak period. This presents not only staffing challenges, but also patronage, customer visitor loyalty, and sales challenges.

### SUMMARY

Various embodiments herein each include systems, methods, software, and devices that contribute in providing interactive in-facility virtual assistance to facility visitors, such as visitors to retail outlets.

One method embodiment that may be implemented on a networked server includes initiating a transaction session between a mobile device and a terminal in response to an initiation input received via a network from the mobile device. The method of such embodiments may then transmit a facility location identifier received from the mobile device to the terminal.

Another method embodiment that may be implemented on a networked terminal, such as a personal computer or mobile device, that may be utilized by assistance personnel includes initiating a transaction session on the terminal in response to a transaction session request relayed from a server and originating on a mobile device. The method may then receive a facility location identifier identifying a location of the mobile device and visitor information. The terminal may then present a least a portion of the received visitor information and a map view of a facility with regard to the facility location identifier.

A further embodiment is in the form of a computing device, such as a mobile device, that may be utilized by a facility visitor. A computing device of such embodiment includes a network interface device, at least one processor, and at least one memory device. The at least one memory device stores instructions, such as a mobile device app, that is executable by the at least one processor to perform data processing activities. The data processing activities include receiving input to initiate a transaction session with a terminal and transmitting, via the network interface device, a transaction session initiation to a network location. The data processing activities further include establishing, via the network interface device, a transaction session with a terminal. The transaction session may include sending and receiving at least one of audio and video respectively to and from the terminal. The data processing activities also include transmitting, via the network interface device, a facility location identifier to the terminal and rendering a map view of a facility and a current location within the map view corresponding to a location of the facility location identifier.

### BRIEF DESCRIPTION OF THE DRAWINGS

FIG. 1 is a logical block diagram of a system, according to an example embodiment.

FIG. 2 is a logical block diagram of a facility deployment of a system, according to an example embodiment.

FIG. 3 is a logical block diagram of a method, according to an example embodiment.

FIG. 4 is a logical block diagram of a method, according to an example embodiment.

FIG. 5 is a logical block diagram of a method, according to an example embodiment.

FIG. 6 is a block diagram of a computing device, according to an example embodiment.

### DETAILED DESCRIPTION

Various embodiments herein each include systems, methods, software, and devices that contribute in providing interactive in-facility virtual assistance to facility visitors, such as visitors to retail outlets.

Some such embodiments enable a facility visitor to obtain assistance on a mobile device as they roam about a facility. The mobile device may be a visitor's own mobile device with an appropriate app installed thereon or a mobile device provided by the facility for visitor use while present at the facility. The mobile device may be a smartphone, tablet, smartwatch, other wearable mobile device, personal computer (e.g., laptop), and the like.

In some embodiments, a visitor in possession of a suitable mobile device with an app installed thereon may select an assistance option within the app to be connected via a network (e.g., WI-FI®, 3G or 4G wireless, etc.) with an assistance employee that may be located in the facility or elsewhere. For example, the assistance personnel may be located within the facility, at another facility operated by the same entity, a visitor assistance center (e.g., employees at a location remote from the facility tasked with servicing in-facility assistance requests), and the like.

When a visitor selects an in-app assistance option, various data may be collected within the app and from various data and hardware elements of the mobile device, in some embodiments. For example, when the visitor has logged in to a customer loyalty account within the app or has otherwise provided personal information (e.g., name, address, phone number, etc.), visitor information, elements of this information may be gathered. Further, location information may be gathered to assist in identifying the facility and where within the facility the visitor located. Such location information may be gathered by one or a combination of visitor input, identifiers received by a radio transceiver device of the mobile device from one or more radio devices deployed in the facility (e.g., beacon device identifiers, Wireless Access Point (WAP) identifiers, etc.), Global Positioning System (GPS) coordinates from a GPS device present on the mobile device, and the like. Additional information may also be gathered, such as a product search history from the app, a question received as input from the visitor, a history of previous locations in the facility the visitor was located, and the like. Once this information is gathered, an assistance request is generated and sent to a network location configured to receive assistance requests.

In some embodiments, this network location may be configured on the mobile device app as a network location within the facility or a location remote to the facility. This network location may be a terminal that will be used to service the request. In other embodiments, the network location is a server process that executes to route received assistance requests to terminals that will service assistance requests. The routing of assistance requests may be performed based on one or more rules. In a simple embodiment, all assistance requests may be queued based on a time of receipt of the request and routed to a pool of terminals. In other embodiments, the rules may be specific to one or more particular facilities, may be dependent on one or more of time of day dependent, facility location, question or request type specific, and the like. In some embodiments, two or more rules may be evaluated in routing requests. For example, one rule may be associated with a facility where a visitor is located that provides for routing the request within the facility during non-peak periods and routing the request elsewhere during peak periods. Another rule may designate when a second facility is capable of handling requests, such as during non-peak periods at the second facility. Thus, when a request is received in the facility during a peak period, a rule associated with that facility will cause a routing process, such as may execute on a server, to determine the request is to be routed to a location outside of the facility. The routing process will then evaluate rules of other facilities to identify a facility capable of servicing the request, which may result in the routing process identifying the second facility according to its peak/non-peak period rule. Once the routing process identifies a location to which the assistance request is to be routed, the request will be sent thereto.

The receiving location of the request, in some embodiments, may be a terminal or a queueing system at the receiving location that provides the request to a first available terminal. Once a terminal receives the assistance request, the terminal and requesting mobile device app connect. The terminal may present the received request within a terminal program user interface, retrieve and present a map of the facility where the request was received from and a location within the facility when know, the received visitor information, and other data that may be included in the assistance request or can be retrieved based thereon. The connection between the terminal and the mobile device may include one or both of a live audio and video connection. The connection may also or alternatively include a text-based chat session. In some embodiments, the use of one or both of audio and video may be enabled and disabled on one or both of the mobile device and the terminal.

In some further embodiments, the connection may also include a screen share between the terminal and the mobile device app. The screen share may be utilized in some embodiments to present product information retrieved and presented by one of the mobile device app and the terminal and share the view with the other. This information may include side-by-side product comparisons and product price comparisons with other retailers which may be used to help complete a sale or to facilitate price matching with a competitor.

Once the connection between the terminal and the mobile device app are established, the visitor may obtain assistance from the terminal operator. In some embodiments, as the visitor moves about the facility, the location of the visitor may be updated within the mobile device app and transmitted to the terminal. In some embodiments, the terminal operator may place a marker on a facility map presented on the terminal and data identifying the location on the facility map may be transmitted to the mobile device app. The mobile device app upon receipt of the location data from the terminal may then place a marker on a map presented within the mobile device app. The visitor may then move about the facility to the location of the marker.

In some embodiments, one or both of the visitor and terminal operator may generate a transaction within the app or application that executes on their respective devices for purchase of one or both of products and services. The transaction, in some embodiments, may be completed within the assistance session. In other embodiments, the transaction may be staged such that when the visitor goes to a checkout terminal, the transaction may be retrieved to allow the visitor to complete the transaction, such as by providing payment.

In some further embodiments, an assistance session may be transferred from one or both of the mobile device app and the terminal application to another mobile device app of the same or another visitor, another assistance terminal, a facility employee at either a terminal or a mobile device, and other locations. Such embodiments that allow for transferring of an assistance session provide flexibility in servicing assistance requests, such as matching a particular request with a subject matter expert when further detail about the request is learned or when the request is multi-part and two parts are with regard to different subject matter.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

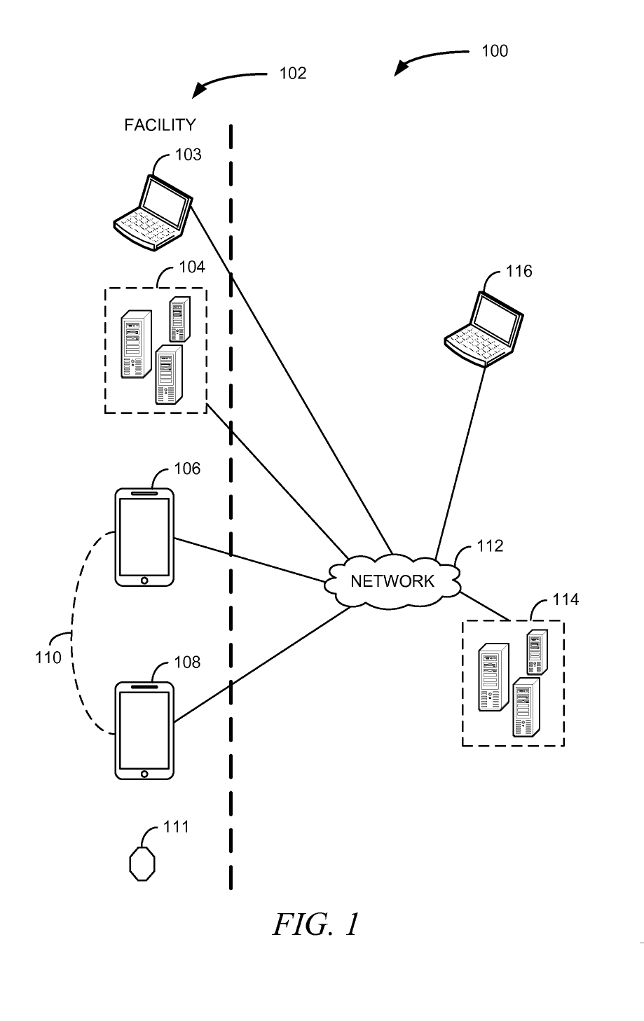

FIG. 1 is a logical block diagram of a system 100, according to an example embodiment. The system 100 is a simplified illustration that includes two mobile devices 106, 108 and a beacon device 111 located within a facility 102. The facility 102 also includes a computing system 104, such as a transaction processing system or store management system that may include transaction processing, inventory, ordering, customer account management, virtual assistant, and other functionality. Each of the mobile devices 106, 108 and the computing system 104 connect to a network 112, such as the Internet. Also connected to the Internet is a backend system 114. The backend system 114 is a generalized representation of a computing system that provides virtual assistant functionality and may maintain customer account data and perform other functions with regard to the facility 102, other facilities, beacon device deployment functionality and configuration, and the like.

The mobile devices 106, 108 may individually be one of a smartphone, a smartwatch, other wearable device-type, a tablet, a laptop computer, and other such computing devices that include a transceiver device, such as one or both of a wireless network interface device and a BLUETOOTH® transceiver. Each of the mobile devices 106, 108 typically includes an app that executes thereon, which may include an app provided by a facility 102 operator that provides virtual assistant functionality. However, some or all of the mobile device functionality may also or alternatively be a part of operating software of one or more device types, such as an operating system and other platform layer software (i.e., BIOS). Thus, when reference is made to a mobile device app herein, this is not intended to limit the scope of the disclosure but should be considered more broadly.

In some embodiments, presence of the mobile device 106 at the facility 102 may be detected. For example, a GPS sensor of the mobile device 106 may identify a position of the mobile device 106 registered in the backend system 114 or computing system 104 in association with the facility 102, location input may be received by the mobile device 106, a signal may be received from a wireless access point or a beacon device including an identifier registered in the backend system 114 or computing system 104 in association with the facility 102, and the like. An app on the mobile device 106 may then transmit data to the backend system 114 including the location data. The mobile device 106 may also transmit data to the backend system that associates the mobile device 106 or the mobile device app session with a customer account maintained in the backend system 114. In such embodiments, a user interface may then be presented to a mobile device user indicating virtual assistance is available.

In other embodiments, a mobile device 106 user may simply open a virtual assistant app on the mobile device and the virtual assistant app may provide a selectable user interface control to generate a virtual assistance request. Note that reference to a virtual assistant app herein is a reference to an app that provides virtual assistant functionality to a mobile device user. The virtual assistant functionality may be provided by a standalone virtual assistant app but may also be provided by an app that provides greater functionality, such as an app that also provides customer loyalty account functionality, product search and shopping functionality, and other functionality.

In some embodiments, the facility 102 includes one or a plurality of beacon devices 111 deployed therein. Each of the beacon devices 111 are deployed at a location registered in one or both of the computing system 104 and backend system 114 in association with a beacon device 111 identifier. Each beacon device 111 identifier is a data item that is broadcast by the respective beacon device 111, such as a MAC address of a BLUETOOTH® beacon device, SSID of a Wireless Access Point (WAP), or other data element that is unique to the particular beacon device 111.

In these and some other embodiments, a mobile device 106, 108 app of one facility 102 visitor may also operate passively as a beacon device. For example, when a location of the mobile device 108 is known in the backend system 114, the mobile device 106 app may receive a radio signal 110 from the mobile device 108, which may then be utilized to identify a location of the mobile device 106. Thus, in some embodiments, apps of both mobile devices 106, 108 may execute in the background to report identifiers included in received radio signals to the computing system 104 or backend system 114. Similarly, a mobile device 106, 108 app may receive a radio signal including a unique identifier of another mobile device 106, 108 whose location is known to the computing system 104 or backend system 114 and that unique identifier will be utilized to determine a location of the receiving mobile device 106, 108. Accordingly, the mobile device 106, 108 location may be determined in the backend system 114 based on receipt of beacon device 111 signals, GPS location from a GPS device of the mobile device, WAP signals, or even user input that is transmitted to the backend system. The received radio signals may be transmitted by other mobile devices, such as by a BLUETOOTH® transceiver of the mobile device 108 while the BLUETOOTH® functionality is turned on. These radio signals may also include a signal strength that may be utilized to determine a relative distance in some embodiments.

The system 100 also includes one or both of terminals 103 and 116 that include virtual assistant functionality deployed thereon. The terminals 103, 116 are terminals that are utilized by facility 102 employees or employees of an operator of the facility 102 that provide assistance to requesting mobile device 106, 108 users. The terminals 103, 116 may be personal computers, mobile devices, and other computing devices in various embodiments. The terminals 103, 116 typically include an application or app deployed thereon that receive virtual assistance requests from mobile devices 106, 108. Requests for virtual assistance may be received over the network 112 directly from a mobile device 106, 108 app or indirectly as may be routed by virtual assistance server processes that are deployed to and execute upon one or both of the computing system 104 and backend system 114.

Within a virtual assistance session, the virtual assistant application or app deployed to the terminals 103, 116 may exchange and output one or both of live video and audio with a mobile device 106, 108 app to which it is connected. Further, location data may be received from or determined based on data received from the mobile device 106, 108 to which it is connected. This location data may be utilized to identify one or both of the facility 102 and a location within the facility 102 where the mobile device 106, 108 to which the virtual assistant application or app of the terminal 103, 116 is connected. A map of the facility may be retrieved from a database or data store local to the terminal 103, 116 and presented on a display of the terminal 103, 116. When a map is presented and a location within the facility 103 is known or determined, that location within the facility may also be presented. Additionally, some embodiments may also present addition data, such as identity and customer loyalty account of the mobile device 106, 108 user that requested virtual assistance.

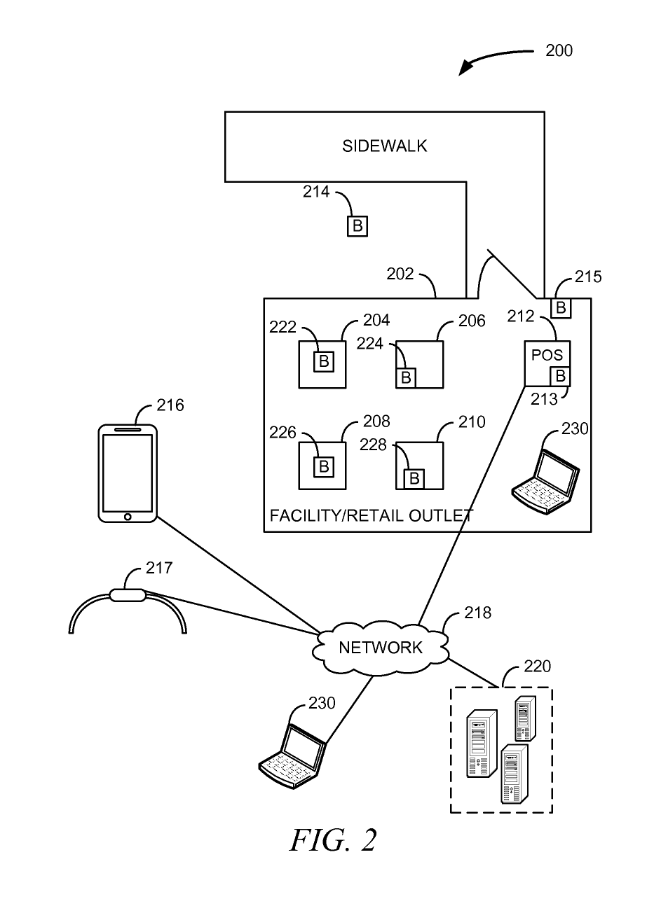

FIG. 2 is a logical block diagram of a system 200, according to an example embodiment. The system 200 is illustrated as deployed with regard to a facility 202, such as a retail outlet, although other embodiments may be deployed to other facility types, such as restaurants, concession stands, casinos, hospitals, and other facility types.

In an example embodiment, a visitor carrying a mobile device 216, 217, such as a smartphone, smartwatch, wearable device, or tablet, may enter the facility 202 with their own mobile device 216, 217. In other embodiments, a visitor may obtain a mobile 216, 217 from a location within the facility 202 as provided by the facility 202 for visitor usage. Regardless of the source of the mobile devices 216, 217, the mobile devices 216, 217 typically include an app that executes thereon that allows the user to request virtual assistance via a network 218 from an assisting employee utilizing a terminal 230. Some embodiments of the mobile device 216, 217 app may perform additional actions and provide additional functionality. The additional actions may include viewing receipts from prior visits, interactions in the facility 202 or other facilities or access points (e.g., websites, kiosks, etc.), completing surveys, viewing a current bill, viewing a facility 202 map, viewing data of appointments and reservations, checking in at the facility with regard to an appointment or reservation, making a payment, searching products and product information, and the like. The mobile device 216, 217 app, in some embodiments, receives data received by a transceiver device present on the mobile device 216, 217, such as one or both of a BLUETOOTH® device and a WI-FI® device. In some embodiments, data may also be received via a GPS device of the mobile device 216, 217. An example of data that may be received by the mobile device 216, 217 app is data from one or more beacon devices 213, 214, 215, 222, 224, 226, 228 deployed in and around the facility 202, such as at facility locations 204, 206, 208, 210, and 213. The data from the one or more beacon devices 213, 214, 215, 222, 224, 226, 228 typically includes identifiers of the respective beacon devices. These beacon device identifiers enable the mobile device 216, 217 app, a backend system 220 service, or terminal 230 app or application to determine a location of the mobile device 216, 217. A beacon device identifier included in data transmitted from a mobile device 216, 217 may also trigger performance of one or more data processing activities configured in the backend system 220 with regard to a particular beacon device 213, 214, 215. The mobile device 216, 217, and the app thereon, may receive data from one of the beacon devices 213, 214, 215, 222, 224, 226, 228 or a plurality of beacon devices 213, 214, 215, 222, 224, 226, 228.

In some embodiments, a mobile device 216, 217 for which a location is known to the backend system 220, may operate as a beacon device for other mobile devices 216, 217. For example, a transceiver device of a mobile device 216, 217, such as a BLUETOOTH® transceiver, periodically broadcasts radio signals when the transceiver is enabled. These signals may be transmitted to determine what other devices may be present and available for connection. These signals typically include a unique identifier encoded therein, such as a MAC address of the transceiver. In some embodiments, a mobile device 216, 217 may receive such a signal and transmit the identifier and an account identifier of the user of the mobile device 216, 217 to the backend system 220 via network 218. A backend system 220 process may then query maintained customer account data that includes such identifiers stored in with or in association with customer accounts. This query is performed based on the identifier to determine if a location is known with regard to a mobile device of that identifier. When a location is known with regard to the identifier, a location of the mobile device 216, 217 from which the data was received is known to the backend system 220. The backend system 220 may then perform additional functions that may be triggered with regard to that location with regard to the particular customer account of the account identifier. Conversely, a mobile device 216, 217 may receive such a signal including a unique identifier from another mobile device 216, 217. The receiving mobile device 216, 217 may then relay the identifier to the backend system 220 and similar processing may occur. Such embodiments may enable locating of a mobile device 216, 217 located where beacon devices 213, 214, 216 are out of range.

In one embodiment, a visitor carrying a mobile device 216, 217 arrives at the facility 202 or obtains a mobile device 216, 217 at the facility. The mobile device 216, 217 may receive a signal from one or both of beacon devices 214, 215 located immediately outside or immediately inside 215 the facility 202. The visitor's location is therefore known as identifiers of the beacon devices 214, 215 are registered in the backend system 220. An app deployed to the mobile device 216, 217 may then present a selectable user interface control that can be selected to initiate a virtual assistance session with a user of the terminal 230. In some embodiments, when the app becomes aware of a location at a facility, the app may provide a notification that virtual assistance functionality is available. The notification may also retrieve or receive and then present information about various promotions at the facility for one or more of products, services, and events. Upon selection on the mobile device, a virtual assistance request is generated, which may include not only the request, but also location data, visitor-identifying data, information about the subject of the request, and the like. The request may then be transmitted over the network 218 directly to the terminal 230 or to the backend system 220. When the request is transmitted to the backend system 220, a process executes on the backend system 220 to route the request to an appropriate terminal 230. The routing may be performed based on routing rules. Routing rules may be defined to load balance virtual assistance requests amongst a plurality of terminals 230, to another facility 202 when the illustrated facility is within a predefined or ad hoc indicated peak period, and other rules. The routing rules, when applied to a received virtual assistance request, result is relaying the virtual assistance request to a terminal 230.

The terminal 230, upon receipt of the virtual assistance request, may present one or both of data received with the virtual assistance request and data retrieved from one or more databases based on data included in the virtual assistance request. The presented data may include data such as visitor identifying data, visitor location data, a map of the facility, current and upcoming promotions and events relevant to the facility, and other data, depending on the embodiment. The virtual assistance session will then be established between the mobile device 216, 217 and the terminal 230. The virtual assistance session may include an exchange of one or both of audio and video from cameras and microphones of the mobile device 216, 217 and terminal 230. The virtual assistance session may also include, along with corresponding user interface elements in both of the mobile device 216, 217 app and terminal 230 application or app, text-based chat messaging. A camera of the mobile device 216, 217 may also be utilized in some embodiments for scanning of product barcodes to obtain product information on one or both of the mobile device 216, 217 and terminal 230.

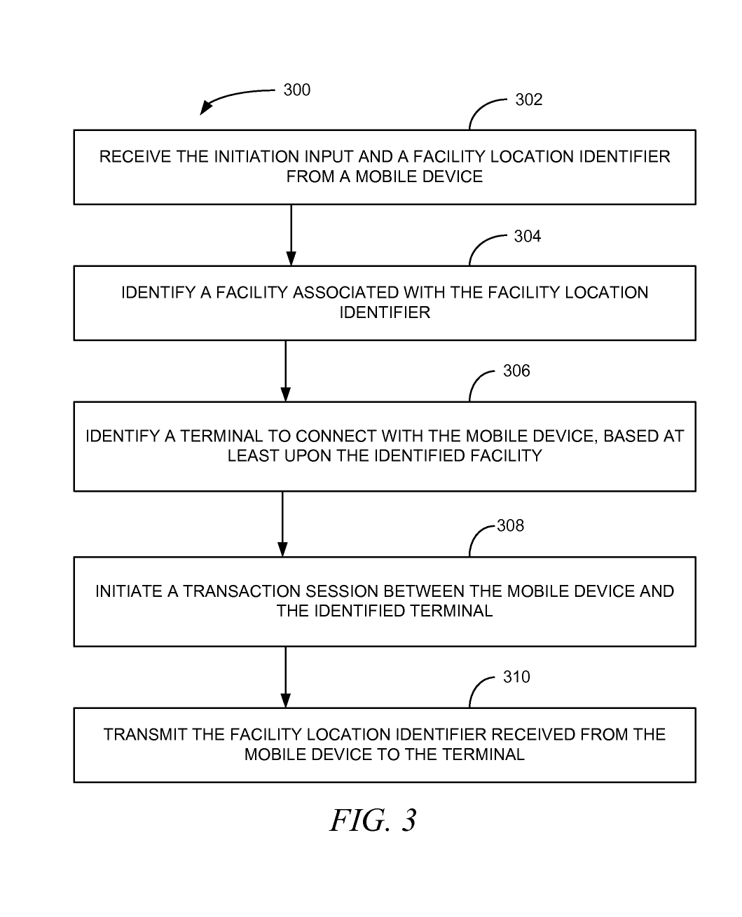

FIG. 3 is a logical block diagram of a method 300, according to an example embodiment. The method 300 is an example of a method that may be executed on a server, such as the computer system 104 or backend system 114 of FIG. 1 in facilitating virtual assistance sessions.

The method 300 includes receiving 302 virtual assistance initiation input and a facility location identifier from a mobile device and identifying 304 a facility associated with the facility location identifier. The facility location identifier may be a GPS location, one or more beacon device or other radio device identifiers, customer input, and the like. The facility location identifier may be utilized in some embodiments to identify 304 the facility by retrieving a facility associated therewith in stored data.

The method 300, in some embodiments, further includes identifying 306 a terminal to connect with the mobile device, based at least upon the identified facility, when initiating the transaction session. The method 300 then initiates 308 a transaction session, also referred to as a virtual assistance session, between the mobile device and the terminal in response. As part of the initiating 308 of the transaction session or in a separate communication, the method 300 also includes transmitting 310 a facility location identifier received from the mobile device to the terminal.

In some such embodiments of the method 300, identifying 306 the terminal to connect with the mobile device when initiating the transaction session is further based upon at least one transaction session configuration rule associated with the identified facility. The at least one transaction session configuration rule may include a transaction session configuration rule including a conditional operator, which when satisfied, causes identification of a terminal at a different location than the facility rather than a default terminal located at the facility.

In some embodiments, the received 302 initiation input includes a customer account identifier. The customer account identifier may be utilized in some embodiments to retrieve customer account data associated with the customer account identifier. The retrieved customer account data may then be transmitted to at least one of the mobile device and the terminal.

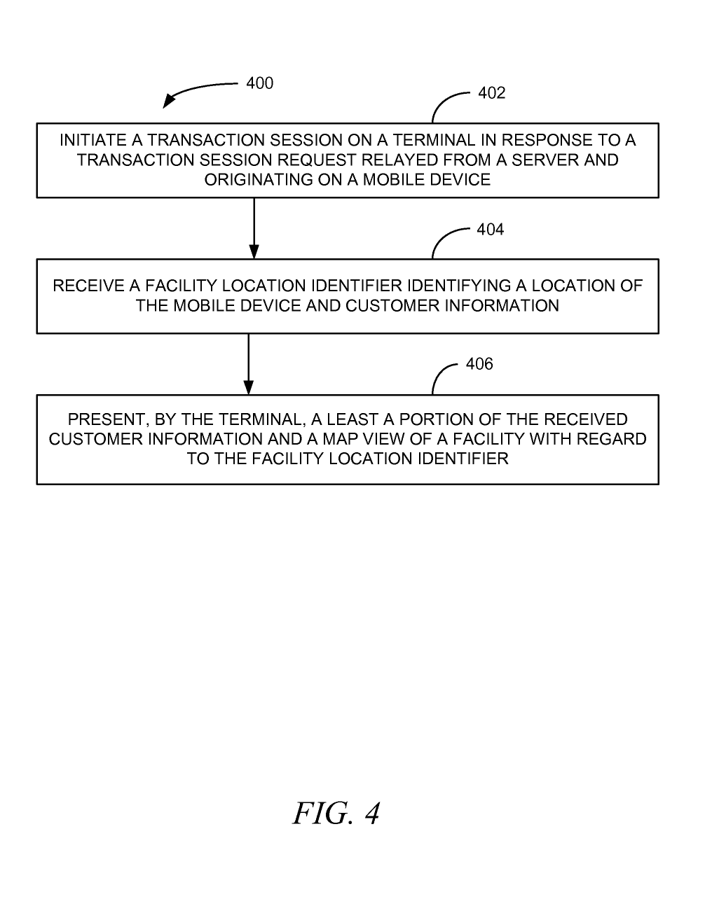

FIG. 4 is a logical block diagram of a method 400, according to an example embodiment. The method 400 is an example of a method executed by a terminal, such as the terminal 116 illustrated and described with regard to FIG. 1 to participate in virtual assistance sessions.

The method 400 includes initiating 402 a transaction session on a terminal in response to a transaction session request relayed from a server and originating on a mobile device. In some embodiments, the initiating 402 of the transaction session may be performed in response to receipt of a transaction session request directly from the mobile device.

The method 400 further includes receiving 404 a facility location identifier identifying a location of the mobile device and customer information. The method 400 may then cause the terminal to present 406 a least a portion of the received customer information and a map view of a facility with regard to the facility location identifier.

In some embodiments, initiating 402 the transaction session includes initiating a live transaction session between the mobile device and the terminal including at least one of video and audio streams between the mobile device and the terminal.

In these and other embodiments, the method 400 includes receiving updated facility location identifiers from the mobile device during the transaction session. The presenting 406 of the map view of the facility with regard to the facility location identifier may include receiving a renderable map to be presented and rendering a graphical element at a location within the rendered map. The graphical element is rendered to identify a location of the mobile device based on the facility location identifier. In such embodiments, the rendering of the graphical element includes updating a rendered location of the graphical element upon receipt of an updated facility location identifier. In some such embodiments, a facility location identifier includes an identifier of a radio device deployed within the facility and associated in configuration data with the facility and a location within the facility.

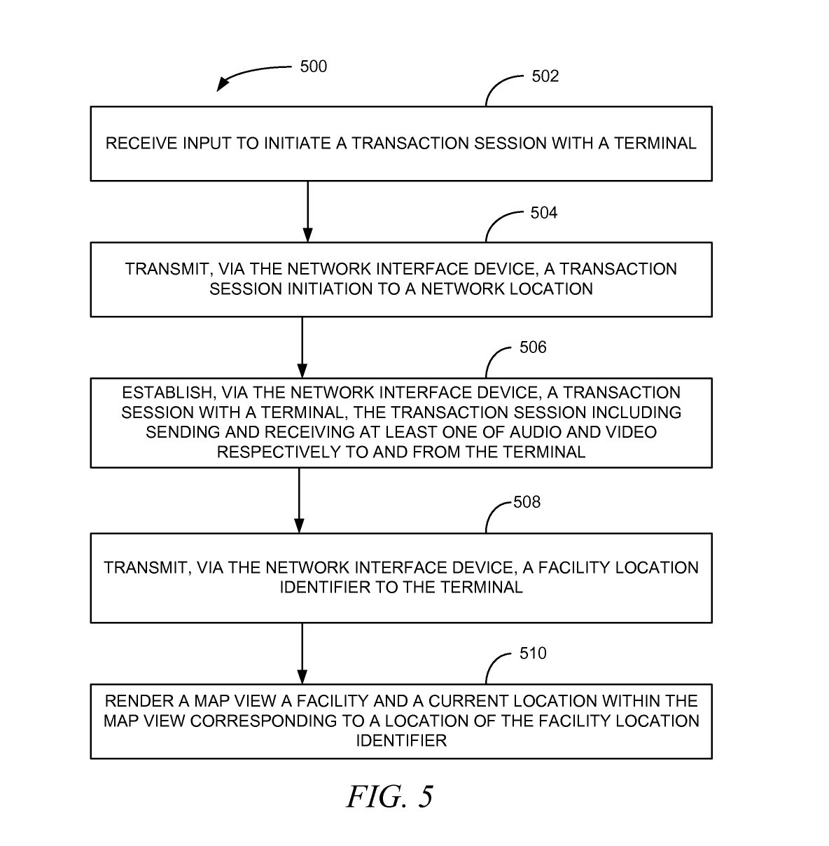

FIG. 5 is a logical block diagram of a method 500, according to an example embodiment. The method 500 is an example of a method executed by a mobile device, such as the mobile devices 106, 108 illustrated and described with regard to FIG. 1 to participate in virtual assistance sessions.

The method 500 includes receiving 502 input to initiate a transaction session with a terminal and transmitting 504, via a network interface device, a transaction session initiation to a network location, such as a server process that will route the transaction session initiation to a terminal or directly to a terminal. The method 500 further includes establishing 506 a transaction session with a terminal. The transaction session in some embodiments includes sending and receiving at least one of audio and video respectively to and from the terminal. The method 500 may then transmit 508 a facility location identifier to the terminal and render 510 a map view a facility and a current location within the map view corresponding to a location of the facility location identifier.

Some embodiments of the method 500 further include, within a transaction session, reading a barcode within an image received within a process performing the method 500 from a camera device of the mobile device on which the method is being executed. Such embodiments further include retrieving and rendering product data based on the read barcode data. Some such embodiments may further include retrieving customer account data based on credential data received as input (e.g., user name and password, fingerprint verification, etc.) and receiving input to add a product of the read barcode data to a current transaction. Some embodiments may also include receiving input to charge an amount due for a current transaction to a payment type associated with the customer account or a payment account received as input. The method 500 may then transmit a payment transaction request to be processed to an appropriate network location.

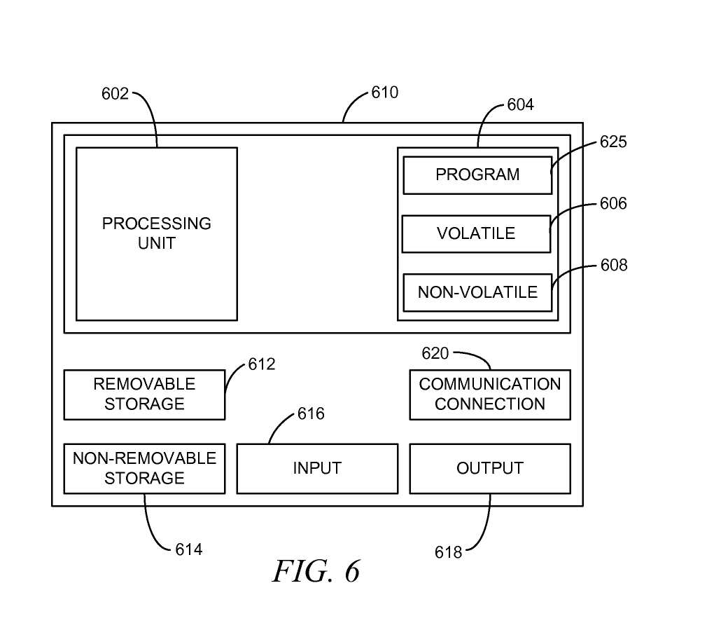

FIG. 6 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 610, may include a processing unit 602, memory 604, removable storage 612, and non-removable storage 614. Although the example computing device is illustrated and described as computer 610, the computing device may be in different forms in different embodiments. For example, the computing device may instead be a smartphone, a tablet, smartwatch, or other computing device including the same or similar elements as illustrated and described with regard to FIG. 6. Devices such as smartphones, tablets, and smartwatches are generally collectively referred to as mobile devices. Further, although the various data storage elements are illustrated as part of the computer 610, the storage may also or alternatively include cloud-based storage accessible via a network, such as the Internet.

Returning to the computer 610, memory 604 may include volatile memory 606 and non-volatile memory 608. Computer 610 may include—or have access to a computing environment that includes a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 610 may include or have access to a computing environment that includes input 616, output 618, and a communication connection 620. The input 616 may include one or more of a touchscreen, touchpad, mouse, keyboard, camera, one or more device-specific buttons, one or more sensors integrated within or coupled via wired or wireless data connections to the computer 610, and other input devices. The computer 610 may operate in a networked environment using a communication connection 620 to connect to one or more remote computers, such as database servers, web servers, and other computing device. An example remote computer may include a personal computer (PC), server, router, network PC, a peer device or other common network node, or the like. The communication connection 620 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 620 may also or alternatively include a transceiver device, such as a BLUETOOTH® device that enables the computer 610 to wirelessly receive data from and transmit data to other BLUETOOTH® devices.

Computer-readable instructions stored on a computer-readable medium are executable by the processing unit 602 of the computer 610. A hard drive (magnetic disk or solid state), CD-ROM, and RAM are some examples of articles including a non-transitory computer-readable medium. For example, various computer programs 625 or apps, such as one or more applications and modules implementing one or more of the methods illustrated and described herein or an app or application that executes on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
initiating a transaction session between a mobile device and a terminal in response to an initiation input received via a network from the mobile device; and
transmitting a facility location identifier received from the mobile device to the terminal.

2. The method of claim 1, further comprising:
receiving the initiation input and the facility location identifier from the mobile device;
identifying a facility associated with the facility location identifier; and
identifying the terminal to connect with the mobile device, based at least upon the identified facility, when initiating the transaction session.

3. The method of claim 2, wherein identifying the terminal to connect with the mobile device when initiating the transaction session is further based upon at least one transaction session configuration rule associated with the identified facility.

4. The method of claim 3, wherein the at least one transaction session configuration rule includes a transaction session configuration rule including a conditional operator, which when satisfied, causes identification of a terminal at a different location than the facility rather than a default terminal located at the facility.

5. The method of claim 2, wherein the facility location identifier is an identifier of a radio device deployed in a facility, the facility location identifier stored in association with stored data of the facility.

6. The method of claim 5, further comprising:
retrieving and transmitting a renderable map of the identified facility to at least one of the mobile device and the terminal.

7. The method of claim 2, further comprising:
receiving a customer account identifier;
retrieving customer account data associated with the customer account identifier; and
transmitting the retrieved customer account data to at least one of the mobile device and the terminal.

8. The method of claim 1, wherein initiating the transaction session includes initiating a live transaction session between the mobile device and the terminal including at least one of video and audio streams between the mobile device and the terminal.

9. A method comprising:
initiating a transaction session on a terminal in response to a transaction session request relayed from a server and originating on a mobile device;
receiving a facility location identifier identifying a location of the mobile device and customer information; and
presenting, by the terminal, a least a portion of the received customer information and a map view of a facility with regard to the facility location identifier.

10. The method of claim 9, wherein initiating the transaction session includes initiating a live transaction session between the mobile device and the terminal including at least one of video and audio streams between the mobile device and the terminal.

11. The method of claim 9, the method further comprising:
receiving updated facility location identifiers from the mobile device during the transaction session; and
wherein presenting the map view of the facility with regard to the facility location identifier includes:
receiving a renderable map to be presented; and
rendering a graphical element at a location within the rendered map identifying a location of the mobile device based on the facility location identifier, the rendering of the graphical element including updating a rendered location of the graphical element within the rendered map upon receipt of an updated facility location identifier.

12. The method of claim 11, wherein a facility location identifier includes an identifier of a radio device deployed within the facility and associated in configuration data with the facility and a location within the facility.

13. The method of claim 12, wherein the radio device is a beacon device.

14. The method of claim 9, wherein the terminal and the mobile device are located within the same facility.

15. A computing device comprising:
a network interface device, at least one processor, and at least one memory device, the at least one memory device storing instructions executable by the at least one processor to perform data processing activities, the data processing activities comprising:
receiving input to initiate a transaction session with a terminal;
transmitting, via the network interface device, a transaction session initiation to a network location;
establishing, via the network interface device, a transaction session with a terminal, the transaction session including sending and receiving at least one of audio and video respectively to and from the terminal;
transmitting, via the network interface device, a facility location identifier to the terminal; and
rendering a map view a facility and a current location within the map view corresponding to a location of the facility location identifier.

16. The computing device of claim 15, further comprising:
at least one radio transceiver device; and
the data processing activities further comprising:
receiving the facility location identifier, the facility location identifier
received wirelessly by the at least one radio transceiver device and is associated in configuration data with the facility and a location within the facility.

17. The computing device of claim 16, further comprising:
at least one camera device;
a microphone; and
an audio output device.

18. The computing device of claim 16, the data processing activities further comprising:
reading a barcode within an image received from one of the at least one camera devices;
retrieving, via the network interface device, and rendering product data based on the read barcode data.

19. The computing device of claim 18, the data processing activities further comprising:
retrieving customer account data based on credential data received as input;
receiving input to add a product of the read barcode data to a current transaction.

20. The computing device of claim 19, further comprising:
receiving input to charge an amount due for a current transaction to a payment type associated with the customer account; and
transmitting a payment transaction request via the network interface account to be processed.
